(19) United States
(12) Patent Application Publication
(10) Pub. No.: US 2011/0229340 A1
(43) Pub. Date: Sep. 22, 2011

(54) PENTAGONAL TRUSS UNIT FOR TURBINE OF GENERATOR AND STRUCTURE FOR GENERATION PLANT USING THE SAME

(76) Inventors: Young-Sil Yu, Seoul (KR); Byung-Sue Ryu, Seoul (KR)

(21) Appl. No.: 13/129,577

(22) PCT Filed: Nov. 12, 2009
(86) PCT No.: PCT/KR2009/006640

§ 371 Date: May 17, 2011

(30) Foreign Application Priority Data
Nov. 17, 2008 (KR) 20-2008-0015256

(51) Int. Cl. F03D 11/04

(52) U.S. Cl. 416/244 R

(57) ABSTRACT

The present invention relates to a pentagonal truss structure for generator and its structure for use in generation plant purpose. The purpose is to provide pentagonal truss structure for generator where solid support of turbine is possible by having truss structure configuration support device and convenient maintenance or replacement work of installed turbine, and generator purpose structure using pentagonal truss structure. Thus, present inventions is located at each upper and lower section of turbine as upper support and lower support to support the rotating turbine, each vertex of above upper and lower support are interconnected, but connect vertex of one support to two vertexes of other support, creating numerous coupling elements forms several triangle shaped truss structure sides, thus above higher support with regular pentagonal planar structure with upper left and right sides, lower left and right sides, and bottom side is composed, above lower support with regular pentagonal planar structure with upper left and right sides, lower left and right sides, and bottom side is composed, and upper left and right sides of lower support is located vertically below the bottom side of higher support, bottom side of lower support located vertically below upper left and right sides of upper support where one side of upper support and one side of bottom support that is located diagonally can maintain mutual parallel, a pentagonal truss unit for turbine of generator and structure for generation plant using the same are the technical essentials.

### FIELD OF TECHNOLOGY

The present invention relates to a truss framework system for supporting turbine used in generation plant and structure for generation plant using the same, in particular, a truss structure that is connected by numerous coupling elements where there are two pentagonal structure frames above and below, which can solidly support turbine with vertical rotating axis, and is about pentagon truss unit for turbine of generator and structure for generation plant using the same for easier construction of large scale generation plant.

### BACKGROUND TECHNOLOGY

In general, wind power generation device that generates electricity using the wind force is being studied by many as an alternative energy source due to depletion of oil, coal, and natural gas etc due to development of industry and population increase.

FIG. 1 shows general wind power generation device.

General wind power generator is composed with turbine (10) that has several blades, which creates rotation force from wind force, generator (20) that produces electricity by rotation of turbine (10), and support device (30) that supports above turbine (10) and generator (20).

In order for above wind power generator to produce stably, turbine needs to be located at high altitude near to the steady flow.

However, to locate turbine like above at high altitude, not only it requires support device with sufficient height, also fixed structure with enough hardness to fix the support device is needed, so it has shortcomings of enormous installation cost and high risk of damage due to strong wind, and many difficulty in maintaining the turbine, generator and primary components.

In addition, it possesses other problems, such as, due to structure of turbine, not only it requires more than min. wind speed of 5˜6 m/sec for sufficient generation, also direction of turbine needs to be controlled depending on wind direction, thus, it is difficult to expect satisfying generation efficiency in regions where wind is comparatively weak and changes frequently, furthermore, operation has to be stopped in cases of typhoon or gust of wind to prevent damages of components.

By considering the problems mentioned above, perpendicular wind power generator system that are able to generate sufficiently even in regions of weak wind power and frequent wind changes are proposed and is in use.

FIG. 2 shows composition of perpendicular wind power generator system.

Above perpendicular wind power generator system is composed by installing turbine (10) on rotating axis that is installed perpendicularly on the support device (30), thus turbine is able to rotate regardless of the direction of the wind, so it have advantage to generate smoothly even in regions where there are frequent change in wind direction.

However, for smooth rotation of turbine installed perpendicularly, upper and lower section of turbine needs to be supported using support device, thus it have problems, in addition to increase in complexity of support device composition, requires more component materials and large installation area for maintaining sufficient hardness.

Applicant has proposed, considering the above problem, a new support structure by registered patent report no. 0744992 (Application number: 10-2006-0057486.)

FIG. 3 shows diagonal drawing of support device described in registered patent report no. 0744992.

Support device mentioned is composed by upper support (41) with triangle planar structure, lower support (42) that is located vertically below mentioned upper support (41) with inverted triangle planar structure, and each vertex of above upper and lower support are interconnected, forming connecting section with six sides in triangle structure by connecting vertex of one support to two vertexes of other support.

Support device, as mentioned is simple structured, so it is able to provide solid and highly space utilized support device using minimum materials, furthermore it has ease in installing several support devices in staked structure, and also have even arrangement structure in interconnected condition.

However, above support device have upper support and lower support in triangle structure, thus has problem of needing to disassemble the entire support device in cases when turbine that is installed within the support device demands maintenance or replacement.

Therefore, in cases when turbine of support device that is located at lower section than other stacked support devices need to be replaced due to damage, there is a drawback of considerable loss in cost, time and manpower because any support devices that are installed above the corresponding turbine needs to be cleared to replace the damaged turbine.

Also, in case when composing generation facility by stacking above support devices, support device located at the lowest section needs to be fixed to the ground with sufficient hardness, to prevent collapse of support device from typhoon or strong wind, so it have drawbacks of needing high expense in ground work and initial construction.

### SUMMARY OF THE INVENTION

### Task Wanted to Resolve

The present invention was made considering the problems mentioned above, thus the purpose of this invention is to provide pentagonal truss unit for turbine of generator and structure for generation plant using the same that is able to solidly support the turbine by composing support device using truss structure, and also is in ease of maintenance or replacement work of turbine installed within.

Another purpose is to provide pentagonal truss unit for turbine of generator and structure for generation plant using the same that are in ease for constructing large-scale generation complex.

### Task Solving Method

The present invention, pentagonal truss unit for turbine of generator which is for achieving the goals mentioned above and resolving the flaw of the previous are each attached on the upper and lower section of turbine that produces electricity using the energy from fluid. As a structure composed with upper and lower support that supports the rotating turbine, and numerous triangle shaped truss structured sides, with numerous coupling elements, that are made by interconnecting each vertexes of above upper and lower support, where vertex of one support is connected to two vertexes of other support, above upper support is composed of planar structure of regular pentagon with upper left and right sides, lower left and right sides, and bottom side, and above lower support is composed of planar structure of regular pentagon with upper left and right sides, lower left and right sides, and bottom side, while upper left and right sides of lower support are located vertically below the bottom side of upper support, and bottom of lower support is located vertically below upper left and right sides of upper support, so one side of upper support and one side of lower support that is located diagonally maintains mutual parallel condition, thus even in case of removing coupling elements connected to one of the side for securing space for maintenance or replacement of turbine, 3 sides of 5 sides that forms the upper support section will support other coupling elements, so the structure does not collapse.

Meanwhile, it is advisable to form the center of mass of mentioned upper support to be located vertically top of mentioned lower support's center of mass.

Also, present invention, structure for generation plant using pentagonal truss unit is composed with upper support that supports upper section of turbine to rotate is formed in regular pentagonal planar structure with upper left and right sides, lower left and right sides, and bottom side, lower support that supports lower section of turbine to rotate is formed in regular pentagonal planar structure with upper left and right sides, lower left and right sides, and bottom side, while upper left and right sides are located vertically below the bottom of upper support, and bottom side is located vertically below upper left and right side of upper support, and pentagonal truss structure that is formed by numerous coupling elements that interconnects each vertexes of above upper and lower support, where vertex of one support is connected to two vertexes of other support. Around one pentagonal truss structure that is placed at the topmost, five pentagonal truss structures are placed below on each level, but newly placed five pentagonal truss structures are placed around, in line to each vertexes of the topmost pentagonal truss structure, forming pyramid structure that mutually supports each pentagonal truss structures.

When mutually connecting above pentagonal truss structures, it is advisable to combine nearby two pentagonal truss structures by mutually combining or sharing one side of lower support of pentagonal truss structure located above with one side of upper support of pentagonal structure located below.

Meanwhile, mutually connect nearby two pentagonal truss structures, but it is advisable to include more support that connects two pentagonal truss structures to form triangle shaped truss structure.

### Effect

According to present invention with characteristics mentioned above, it is able to securely support the turbine using the truss structure, and even in case of removing coupling elements connected to one side of lower support, collapse of structure does not occur due to support on three sides of upper support by rest of coupling elements, thus maintenance and replacement work of turbine can be done in ease.

Also, for building large-scale generation complex by combining several truss structures, each truss structures that are mutually connected supplements structurally, thus building large-scale building became simple because complex groundwork are no longer required.

### BRIEF DESCRIPTION OF DRAWINGS

FIG. 1 is side view drawing of general wind power generator.

FIG. 2 is diagonal drawing that shows components of vertical wind power generator.

FIG. 3 is diagonal drawing of support device shown in registered patent report no. 0744992.

FIG. 4 is a diagonal drawing of pentagonal truss structure based on advisable implementation of present invention.

FIG. 5 is front view drawing of FIG. 4.

FIG. 6 is floor plan of FIG. 4.

FIG. 7 is bottom view drawing of FIG. 4.

FIG. 8 is a diagonal drawing that shows combination structure of coupling element and joint.

FIG. 9 is a diagonal drawing that shows turbine for wind power generator installed within pentagonal truss of present invention.

FIG. 10 is a diagonal drawing of structure for generation plant using truss structure of present invention.

FIG. 11 is floor plan of FIG. 10.

FIG. 12 is front view drawing of FIG. 10.

FIG. 13 is a diagonal drawing of connection condition of two nearby truss structure shown in FIG. 10.

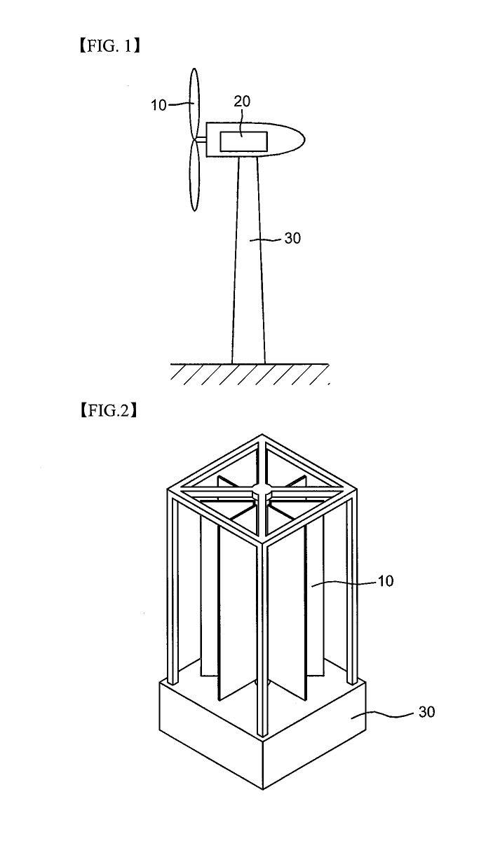

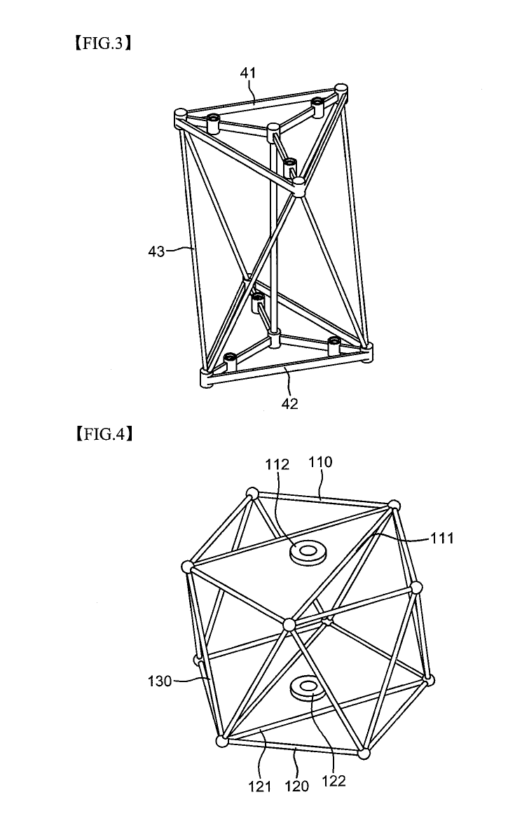

### THE BEST MODE OF EMBODIMENTS

The present invention, pentagonal truss unit for turbine of generator which is for achieving the goals mentioned above and resolving the flaw of the previous are each attached on the upper and lower section of turbine that produces electricity using the energy from fluid. As a structure composed with upper and lower support that supports the rotating turbine, and numerous triangle shaped truss structured sides, with numerous coupling elements, that are made by interconnecting each vertexes of above upper and lower support, where vertex of one support is connected to two vertexes of other support, above upper support is composed of planar structure of regular pentagon with upper left and right sides, lower left and right sides, and bottom side, and above lower support is composed of planar structure of regular pentagon with upper left and right sides, lower left and right sides, and bottom side, while upper left and right sides of lower support are located vertically below the bottom side of upper support, and bottom of lower support is located vertically below upper left and right sides of upper support, so one side of upper support and one side of lower support that is located diagonally maintains mutual parallel condition, thus even in case of removing coupling elements connected to one of the side for securing space for maintenance or replacement of turbine, 3 sides of 5 sides that forms the upper support section will support other coupling elements, so the structure does not collapse.

The present invention, structure for generation plant using pentagonal truss unit is composed with upper support that supports upper section of turbine to rotate is formed in regular pentagonal planar structure with upper left and right sides, lower left and right sides, and bottom side, lower support that supports lower section of turbine to rotate is formed in regular pentagonal planar structure with upper left and right sides, lower left and right sides, and bottom side, while upper left and right sides are located vertically below the bottom of upper support, and bottom side is located vertically below upper left and right side of upper support, and pentagonal truss structure that is formed by numerous coupling elements that interconnects each vertexes of above upper and lower support, where vertex of one support is connected to two vertexes of other support. Around one pentagonal truss structure that is placed at the topmost, five pentagonal truss structures are placed below on each level, but newly placed five pentagonal truss structures are placed around, in line to each vertexes of the topmost pentagonal truss structure, forming pyramid structure that mutually supports each pentagonal truss structures.

### DETAILED DESCRIPTION FOR IMPLEMENTATION OF INVENTION

Advisable implementation example of present invention is described in detail with attached drawings as following.

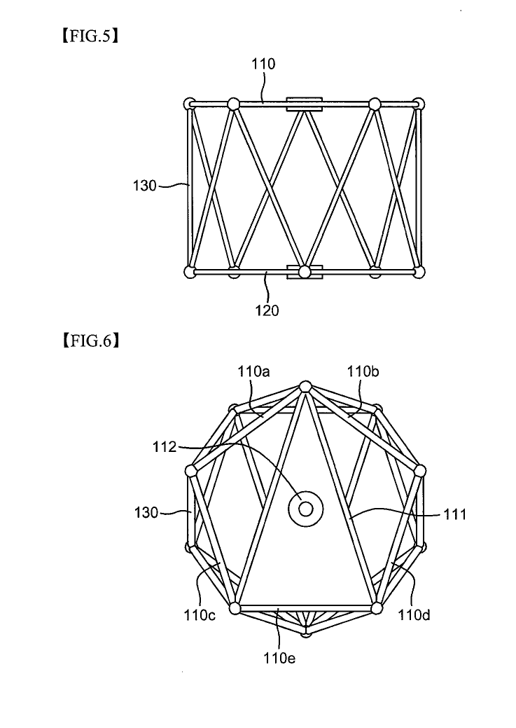

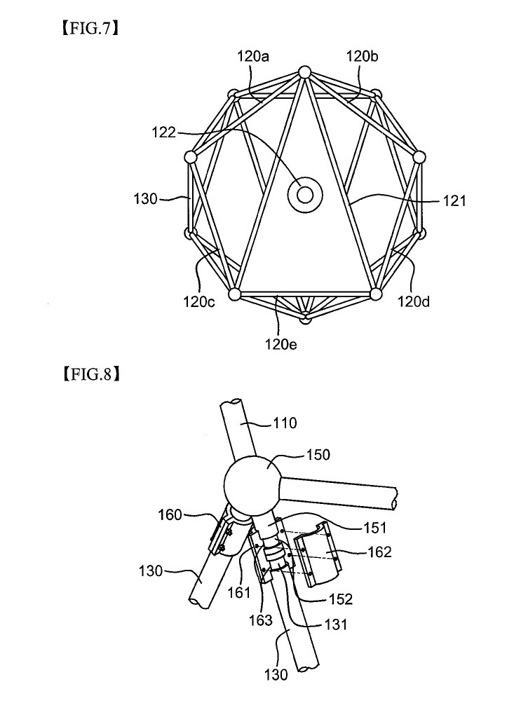

FIG. 4 shows the diagonal drawing of pentagonal truss structure based on advisable implementation example of present invention, FIG. 5 shows the front view drawing of FIG. 4, FIG. 6 shows the floor plan of FIG. 4, and FIG. 7 shows the bottom view of FIG. 4.

Pentagonal truss unit for turbine of generator based on advisable implementation example of present invention uses truss structure to support generator purpose turbine so it has simple and solid support structure and ease in ensuring space for maintenance and replacement of turbine installed within the structure, and ease in building large-scale generation complex, it is composed with upper support (110), lower support (120), and coupling elements (130.)

Above upper support (110) is located at upper section of turbine, supporting top part of the turbine to rotate. This upper support (110) forms pentagonal planar structure comprised of upper left and right sides (110a, 110b), lower left and right sides (110c, 110d), and bottom side (110e). It is advisable to consist of regular pentagonal structure with identical length of each side.

Meanwhile the inner of upper support (110) is installed with stiffener (111) for structural supplement and bearing block (112) for supporting rotation axis that extends from turbine, and these stiffener (111) and bearing block (112) can be installed without specific structure, in various structure depending on designer, so detailed explanation will be omitted.

Above lower support (120) is located at lower section of turbine, supporting bottom part of the turbine to rotate. This lower support (120) is located vertically below upper support (110) with some separation from upper support (110), and like upper support (110), it forms pentagonal planar structure comprised of upper left and right sides (120a, 120b), lower left and right sides (120c, 120d), and bottom side (120e). Stiffener(121) and bearing block (122), of course, are installed within this lower support (120).

Although lower support (120) mentioned above is formed the same as upper support (110), regular pentagonal planar structure with five identical side length, but it forms reverse pentagonal planar structure that has reverse of pentagon formed by upper support (111). If described in more detail, upper left and right sides (120a,120b) of lower support (120) is located vertically below bottom side (110e) of upper support (110), and bottom side (120e) of lower support (120) is located vertically below upper left and right sides (110a, 110b) of upper support (110).

When built in this structure, one side of upper support (110) and one side of lower support (120) that is located diagonally will always have parallel position relationship, so in case workspace for maintenance or replacement of turbine (300) installed within the structure is needed, workspace can be obtained by removing coupling elements that are connected to one of side of lower support (120), and at this point, rest of coupling elements support three sides of upper support (110) so it is able to prevent collapse of structure even when some coupling elements are removed.

Especially structure like above, even in case of removal of some coupling elements for maintenance of turbine installed within a structure formed by combination of present invention that will be mentioned later, it will maintain solid structure, thus holds advantage in providing ease of maintenance of large-scale generation complex.

Meanwhile, it is advisable to have center of mass of upper support (110) mentioned to be located vertically above center of mass of lower support (120.) It's because upper support (110) and lower support (120) are supporting each upper and lower section of rotation axis that is extended from turbine to rotate, by having center of mass of upper support (110) and lower support (120) to locate in the same vertical line to improve structural stability.

Above coupling elements (130) are used to form the structure that holds the turbine within by connecting upper support (110) and lower support (120), and many coupling elements are provided to mutually connect each vertex of upper support (110) and lower support (120.) These each coupling element (130) are formed in pipe or connected directly, and when mutually connecting each vertex of upper support (110) and lower support (120), vertex of one of the support will be connected to two vertexes of other support.

By connecting coupling elements (130) from one vertex of support to two vertexes of different support like above, triangle shaped truss structure is formed, when upper support (110) and lower support (120) that has pentagonal planar structure are connected by above mentioned method using coupling materials, 10 triangle shaped truss structures are formed. It is a common knowledge that these triangle shaped truss structure are able to disperse the load appropriately, thus forms stable structure, so it is able to solidly support the turbine that is producing electricity using the pressure of fluid.

Parts that form upper support (110) and parts that form lower support (120) and coupling elements (130) that are mentioned above are mutually connected by joints, and at this time, unless of extreme special case parts that form upper support (110) and lower support (120) and joints are not asked to be assembled/disassembled so it can be connected via welding, but it is advisable to keep above coupling elements and joint to be assemblable/disassemblable.

FIG. 8 shows the diagonal drawing of combination structure of coupling elements and joints.

Above joint (150) is part where upper support (110) and coupling element (130) are connected, and is installed at part where lower support (120) and coupling element (130) are connected, so for ease in assemble/disassemble of coupling element (130), extra connection flange (160) is used for combining with coupling element (130).

In more detail, bar (151) for combining with connection flange (160) is equipped at joint (150), and slot (152) is made on the bar (151) exterior for binding with connection flange (160.) Also a slot (131) for binding with connection flange (160) is made on the end of coupling element (130).

Above connection flange (160), two flange elements (161, 162) cover the bar (151) and coupling elements (13) and is binded by bolt and nut, thus joint (150) with connection flange (160) is bind, and bump is built on the interior of flange elements (161, 162) so it can be inserted to the slot (152,131) built on the bar (151) and coupling element (130).

If joint (150) and coupling element (130) is connected in above structure, supervisor will be able to easily disassemble coupling element (130) when maintenance or replacement of turbine is required.

Binding structure of coupling element (130) and joint (150) like above is to give an example of structure that is capable of assemble and disassemble of coupling element (130) and joint (150), structure of present invention is not limited these structure, and joint with different structure can be formed and used to assemble/disassemble coupling element (130) and joint (150).

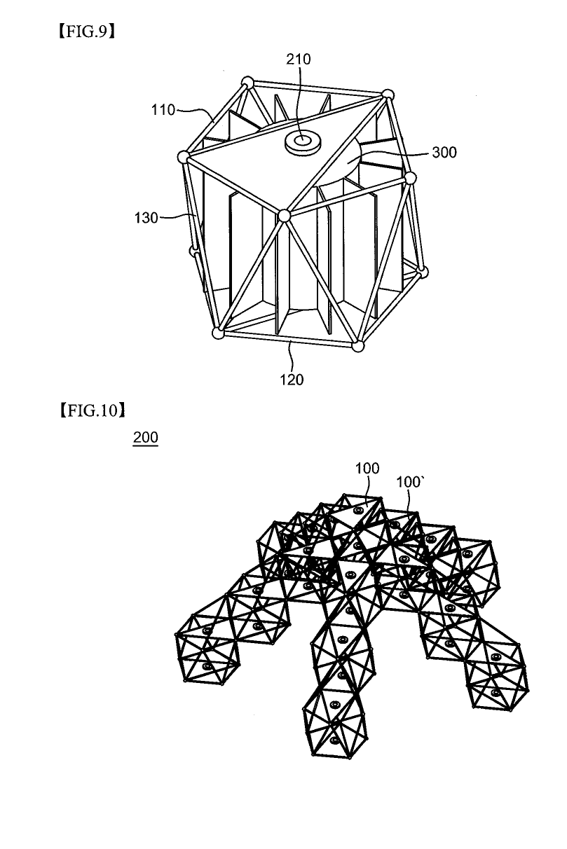

FIG. 9 shows the diagonal drawing of pentagonal truss based on present invention, with turbine for wind power generator installed within.

Turbine (300) for wind power generator is installed within pentagonal truss structure of present invention, upper section of rotation axis (210) that is extended to top of turbine (300) is combined to upper support with rotation ability, and lower section of rotation axis that is extended to bottom of turbine is combined to lower support (120) with rotation ability. Rotation axis, of course, is connected to unshown generator, delivering power from rotation of turbine (300) to the generator.

Pentagonal truss structure of present invention can be used independently to support one turbine, but it can be used for forming structure for building large-scale wind power generation complex.

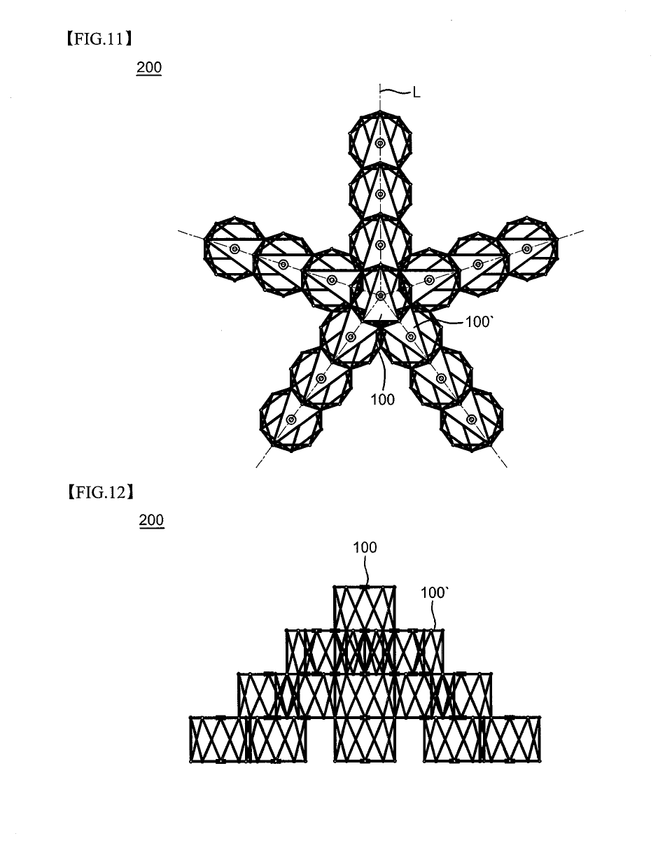

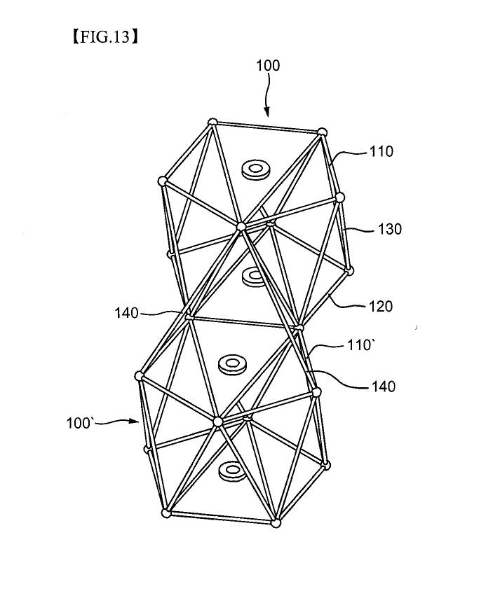

FIG. 10 shows the diagonal drawing of structure for generation plant using the truss structure based on present invention, FIG. 11 shows the floor plan of FIG. 10, FIG. 12 shows the front view drawing of FIG. 10, FIG. 13 shows diagonal drawing of connection condition of two nearby truss structure in FIG. 10.

For explaining structure of present invention, one pentagonal structure located at the topmost of pyramid will be given with drawing number 100, and drawing number 100′ will be given to rest of pentagonal truss structures below of pentagonal truss structure (100).

Structure (200) for generation plant based on present invention is formed by mutual connection of several pentagonal truss structures which looks like a pyramid shape structure, around one pentagonal truss structure (100) that is placed at the topmost, five pentagonal truss structures (100′) are placed below on each level, newly placed five pentagonal truss structures (100′) are located on the extension line (L) from the vertexes of pentagonal truss structure (100) placed at the topmost, thus each pentagonal truss structures are mutually supporting and formed pyramid structure.

In mutually connecting pentagonal truss structures, one side of lower support (120) of pentagonal truss structure (100) located at upper section and one side of upper support (110′) of pentagonal truss structure (100′) located at lower section are mutually combined or shared so two nearby pentagonal truss structure (100,100′) are combined, and for advisable formation of structure would be one side of lower (120) of pentagonal truss structure (100) and one side of upper support (110′) of pentagonal truss structure (100′) being shared by two pentagonal truss structure (100,100′.) FIG. 13 shows these structures.

As brief explanation on the process of producing structure for generation plant with above structure, install five pentagonal truss structures on the floor with certain distance between others depending on the size of design, install additional five pentagonal truss structure on upper section of each five pentagonal truss structures installed on the floor with certain distance apart. On each pentagonal truss structure that is installed on the floor, of course one pentagonal truss structure is combined for each, and newly combined pentagonal truss structure is placed toward the topmost of pyramid.

Form pyramid structure by installing five new pentagonal truss structures for each level, and complete structure for generation plant of pyramid structure by installing one pentagonal truss structure at the peak of pyramid.

For installing other pentagonal truss structure (100) on upper section of pre-installed pentagonal truss structure (100′), work can be done by installing pentagonal truss structure (100) that has been completed through separate manufacturing process on pre-installed pentagonal truss structure (100′) or assemble lower support (120), coupling elements (130), and upper support (110) by stages and directly manufacture new pentagonal truss structure (100) at the site and assemble on pre-installed pentagonal structure (100′).

Also for solid combination of two nearby pentagonal truss structures (100, 100′), it is advisable to combine two pentagonal truss structures (100, 100′) using extra support (140), and even in this cases, structurally stable structure can be provided using minimum elements by forming triangle shape truss structure using support (140).

In these completed structure (200) for generation plant, pentagonal truss structure located at the peak is in the center of pentagon and several pentagonal truss structure (100′) forms planar structure that is extended from each vertex and forms pyramid.

In each of pentagonal truss structure within the structure (200) for generation plant as mentioned above, has a turbine that produces electrify using the energy from fluid, and produced power from each turbine is either delivered to one generator or generator is connected to each turbine for generation.

Like structure (200) for generation plant of present invention, each of pentagonal truss structures are mutually connected to maintain structural supplement relation, having an advantage of not requiring for excessive groundwork.

The present invention is not restricted to specific advisable implementation example described, and those does not exceed the claim made on present invention in the claim scope and anyone who has normal level of knowledge in the technology field within the invention are able to perform various modified implementation, and those kind of changes lays within the range of claim scope.

The present invention is not restricted to specific advisable implementation example described. Anyone who has normal level of knowledge in the technology field within the invention is able to perform various modified implementation, and those kind of changes lays within the range of claim scope.

### APPLICABILITY IN INDUSTRIALS

In case of development of industry and increase of population, oil, coal, natural gas etc are depleted gradually. Apply the pentagonal truss unit of generator of the present invention to the wind power generation device can be an alternative energy source.

1. Pentagonal truss unit for turbine of generator, each attached on the upper and lower section of turbine (300) that produces electricity using the energy from fluid. As a structure composed with upper support (110) and lower support (120) that supports the rotating turbine, and numerous triangle shaped truss structured sides, with numerous coupling elements (130), that are made by interconnecting each vertexes of above upper support (110) and lower support (120), where vertex of one support is connected to two vertexes of other support, above upper support (110) is composed of planar structure of regular pentagon with upper left and right sides (110a,110b), lower left and right sides (110c,110d), and bottom side (110e), and above lower support (120) is composed of planar structure of regular pentagon with upper left and right sides (120a, 120b), lower left and right sides (120c, 120d), and bottom side (120e), while upper left and right sides (120a, 120b) of lower support (120) are located vertically below the bottom side (110e) of upper support (110), and bottom side (120e) of lower support (120) is located vertically below upper left and right sides (110a, 110b) of upper support (110), so one side of upper support (110) and one side of lower support (120) that is located diagonally maintains mutual parallel condition, thus even in case of removing coupling elements connected to one of the side for securing space for maintenance or replacement of turbine, 3 sides of 5 sides that forms the upper support section will support other coupling elements, so the structure does not collapse.

2. According to claim 1,
Pentagonal truss unit for turbine of generator where center of mass of mentioned upper support (110) to be located vertically top of mentioned lower support's (120) center of mass.

3. Structure for generation plant using pentagonal truss unit, composed with upper support (110) that supports upper section of turbine (300) to rotate is formed in regular pentagonal planar structure with upper left and right sides (110a, 110b), lower left and right sides (110c, 100d), and bottom side (110e), lower support (120) that supports lower section of turbine (300) to rotate is formed in regular pentagonal planar structure with upper left and right sides (120a, 120b), lower left and right sides (120c, 120d), and bottom side (120e), while upper left and right sides (120a, 120b) are located vertically below the bottom side (110e) of upper support (110), and bottom side (120e) is located vertically below upper left and right side (110a, 110b) of upper support (110), and pentagonal truss structure that is formed by numerous coupling elements (130) that interconnects each vertexes of above upper support (110) and lower support (120), where vertex of one support is connected to two vertexes of other support.
Around one pentagonal truss structure (100) that is placed at the topmost, five pentagonal truss structures (100) are placed below on each level, but newly placed five pentagonal truss structures are placed around, in line (L) to each vertexes of the topmost pentagonal truss structure, forming pyramid structure that mutually supports each pentagonal truss structures.

4. According to claim 3,
Structure for generation plant using pentagonal truss unit, when mutually connecting above pentagonal truss structures, combine nearby two pentagonal truss structures by mutually combining or sharing one side of lower support (120) of pentagonal truss structure (100) located above with one side of upper support (110′) of pentagonal structure (100′) located below.

5. According to claim 3,
Structure for generation plant using pentagonal truss unit, mutually connect nearby two pentagonal truss structures, but include more support (140) that connects two pentagonal truss structures to form triangle shaped truss structure.

6. According to claim 4,
Structure for generation plant using pentagonal truss unit, mutually connect nearby two pentagonal truss structures, but include more support (140) that connects two pentagonal truss structures to form triangle shaped truss structure.
